(19) United States
(12) Patent Application Publication
(10) Pub. No.: US 2009/0210303 A1
(43) Pub. Date: Aug. 20, 2009

(54) System and method for providing targeted promotions to a self-selected group

(75) Inventors: Kathleen A. Perry, Milwaukee, WI (US); Andrew M. Brezinsky, Brookfield, WI (US)

Correspondence Address: FOLEY & LARDNER LLP, 777 EAST WISCONSIN AVENUE, MILWAUKEE, WI, 53202-5306, US

(73) Assignee: Brevient Technologies, LLC

(21) Appl. No.: 12/069,933

(22) Filed: Feb. 14, 2008

(51) Int. Cl. G06Q 30/00

(52) U.S. Cl. 705/14

(57) ABSTRACT

A system and method for providing a targeted promotional message to a self-selected group of members. A member database includes a plurality of member profiles. Each member profile includes at least a plurality of a region designation, a promotional message preference selection, and a message quantity selection. The system further includes a messaging engine configure to transmit one or more messages to at least one member in the member database based on the member profile for that member. In a preferred embodiment, an auction engine is used to select one or more promoters from a larger group of promoters who desire to send promotional messages to a self-selected group of members.

### CROSS REFERENCE TO RELATED PATENT APPLICATION

This application claims the benefit of U.S. Provisional Application No. 60/901,473, filed Feb. 15, 2007 and entitled, System And Method For Providing Targeted Promotions To A Self-Selected Group, and which is incorporated in its entirety by this reference.

### BACKGROUND

The present application relates generally to the field of promotional advertising. More specifically, the present application is directed to a system and method for providing targeted promotional message to a self-selected group of members.

### BRIEF DESCRIPTION OF THE DRAWINGS

FIG. 1 is a member group representation, according to an exemplary embodiment;

FIG. 2 is a member group representation illustrating a member having selected three preferences, according to an exemplary embodiment; and

FIG. 3 is a member group representation illustrating members that will receive a promotional message based on their selected preferences, according to an exemplary embodiment.

### DETAILED DESCRIPTION

The present application is directed to a method and system which can be used for promoting a nearly infinite number of potential products and services. Exemplary products and services that may be promoted includes nightlife activities, particularly those provided by restaurants, movies and bars/clubs.

The present application is further directed to a system and method for sending a timely message paid for by a venue owner/promoter to a targeted audience that meets criteria established by individual members. The messages may be specifically configured based on user selections and/or limited in their frequency so that the messages offer perceived value to the user and are not perceived as spam. Preferably, the described system and method allows the right message to be delivered at the right time.

The system and method may be implemented through the development of a database in which users (members) designate preferences for obtaining real time information concerning nightlife activities. Promoters send those people such information through the described system and method based on member selected preferences. Members may then have the ability to rate the value of promotions received, leading to financial benefits for promoters having quality participation.

The database may be created in a wide variety of ways, including word-of-mouth references to a sign-up website, print advertising, digital sinage, TV advertising, coupons, mail advertising, etc., with special emphasis placed on establishing relationships at a localized level to infiltrate local businesses. A second proposed recruitment technique is to use theaters, movies, sporting events, retail outlets and the like. For example, promoters for the described system and method may purchase an advertising spot at a theatre chain to be shown in the minutes before a movie begins. Patrons about to view the movie may use their cell phones to text message a number and be included in a random drawing to win a camera/cell phone/TV, etc.

Those patrons that choose to participate may be automatically entered into the user database associated with the described system and method and receive a message describing the promotion system and a link, such as a Web URL address for signing up. Buzz promoting the system and method may be created by naming the winner at the event itself and presenting the prize, e.g., in the theatre lobby. For sporting events, the prize presentation may be done at the end of quarters, innings and the like.

One initial target audience will be 18 to 32 year old cell phone users who are already proficient at and high users of mobile phones and text messaging. The particular age group is not critical to the invention. Another exemplary implementation may use primarily email and involve retired individuals having interests in dinner or senior citizen nightlife opportunities. The prototype of the younger age group, text messaging and nightlife venues is one exemplary market that can be penetrated quickly and expanded to cover specific and relatively well defined locations throughout the United States and the world.

Although specific systems and methods for disseminating the promotional messages have been described, it should be understood that the described system and method may be implemented using any mass messaging system and method. There are a number of terms currently used for text messaging, including, for example, Short Message Service (SMS), “texting,” mobile communications, cell phone messaging, etc. There are also a variety of terms that can be used for promotions, such as preferences, categories or priorities, advertisements, deals, etc. The database itself my likewise be called an online community, social community, member database, etc.

The types of preferences which can be selected by participating members are widely dependent upon the type of service or product, geographic location, demographics, financial characteristics of the market, and the like. For nightlife, users could select the number of text messages (e-mails, calls, texts, etc.) the individual user will accept on a per day, per week, or even time-of-day basis. The user can also select the types of promotions, such as two-for-one entree offers, free appetizer offers, half-price or two-for-one movie promotions, free drink offers, drink specials, waiver of cover charges at clubs, etc. The user may also identify a geographic region within which he or she is willing to look at offers. In connection with nightlife, an entire city (or larger geographic region) could be designated (e.g., Milwaukee, Wis. U.S.A.), as well as regional venues such as “the East Side,” “Brady Street,” “the Third Ward,” “Downtown,” and the like. The dividing lines between regional locations could be determined by popular culture standards, zip code, NAICS, etc. Moreover, if a member desires, a region can be national or international. For example, if the promotion is of concerts by a musician or vocalist, members may be interested in venues remote from their homes or businesses.

Member identification, specifically phone numbers and contact information, should be maintained, in confidence, and would never be made fully available to any company or entity choosing to send promotions. However, the demographics of the user group could be disclosed, including numbers, locations, ages, phone prefixes, income, etc.

Members will have options for selecting quiet times, vacation time, and, of course, discontinuing the receipt of all messages. Members also may choose to switch their primary location temporarily of permanently, allowing them to match their preferences with user ratings and preferred promotion types in a new primary destination. The described system and method may also be used with travel companies, bureaus or hotels to send messages to “out-of-town” guests or to prepare travel portfolios based on a member's preferences.

Anti-spam, spy ware filters and other privacy systems commonly used in modern electronic communications can be deployed within the system. The system may operate with all major cellular providers, as well as on the Internet. It is believed that cell phone providers will readily grant partnerships to the described system and method, due to the expanded use of the services from which they receive fees from the users. The described system and method may be configured to pay a per message charge in its contracts with these providers.

Users may see signs and advertisements at participating promotion venues and can use direct inbound dial (DID) voice call-in, short massaging system (SMS), smart codes, websites, or even handwritten sign-up forms. Once a user has indicated an initial interest through any of these means, they will be sent sign-in information allowing them to register and set initial preferences. If they do not promptly sign up, a reminder may be sent 36 hours later. Following the 36 hours, the initial indication of interest may be ignored.

Smart screens, drop-down menus, radio buttons, and the like may be used for designating preferences. The amount of detail in the preferences is not critical, but could get into such detail as drink preferences, types of movies, food categories, ethnic food preferences, etc. By opting to set preferences, members dictate what information and how much information they receive, making them a more targeted, valuable audience for advertisers and ensuring that the messages they receive are not perceived as spam since they were requested.

The objective of setting up a database containing customers who have designated preferences will be to sell to venues the “opportunity” of sending very targeted promotions to customers who have indicated a preference to the location-based offerings. For example, a bar owner could send, through the system and method, a text or voice offer to those who have indicated that they desire offers on Wednesday nights, for two-for-one margaritas or free burritos (common offers in downtown Milwaukee). Other users who have not designated such preferences will not receive that message. They may receive an entirely different message based on their demographics and different preferences, or they may receive no message at all if there are no promotions matching their criteria at that point in time. A member who has indicated a willingness to receive a broad category of messages and a higher number of messages, such as any food promotion in downtown Milwaukee and up to three messages, could receive more messages.

The constraint on the number of messages received may be set by the user, but may be limited by the system and method to three per day, for example. Such a limitation may be implemented to prevent system abuse.

The marketing of the database and sales or promotion opportunities using the described system and method to promoters may be handled by a marketing staff using any and all tools currently used to advertise promotional services. Contacts may be made directly at the venues, using ads in newspapers, websites, magazines, billboards, in-flight magazines, posters at large volume venues (theatres, arenas, retail outlets, malls, etc.), bus signage, etc. A partnership may also be formed with advertising agencies and corporate distributors looking to use a new promotional tool and access existing groups of customers.

When the program succeeds, and the database grows, the system enables targeted, time-sensitive advertising to specific user groups unavailable through any other type of service. It offers demographic and psychographic advertising preference dictated by members, making the system ideal, especially for local businesses.

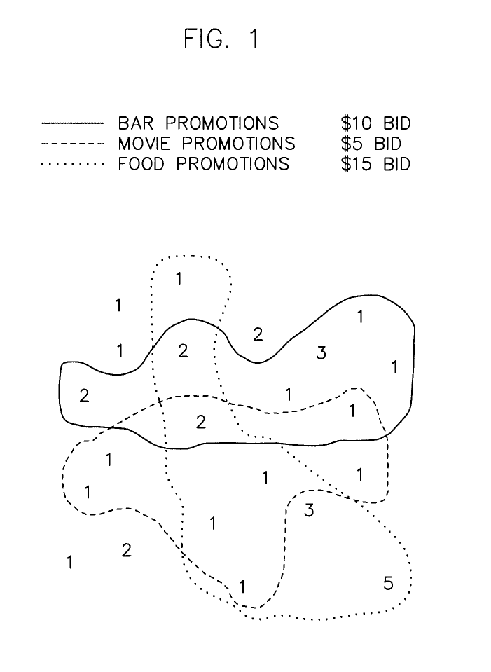

Referring now to FIG. 1, an example of a promotion targeting selected members is described, according to an exemplary embodiment. Restaurant A knows from material furnished by a promoter of the described system and method that a user database of individuals willing to receive promotions is available to it for promotions. Restaurant A may design the promotion message using its advertising agency or other resource. Restaurant A also decides on a demographic group it desires to reach, for example, 18 to 32 year olds who are willing to receive free food offers on Thursday nights in Milwaukee. Restaurant A also is aware that other promoters may also wish to reach the same or a similar group of members as defined by this set of criteria.

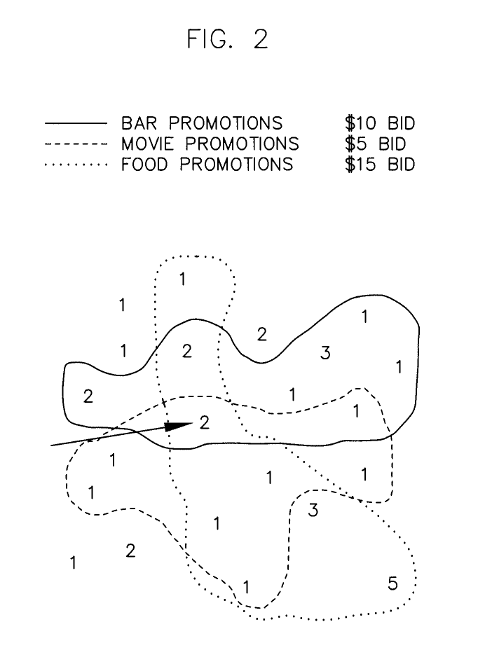

In FIG. 1, each number represents a member of the described system. The number displayed indicates the number of messages that the particular member has opted to receive on a given night. Each colored line contains the members who have said they are willing to receive a specific type of promotional message. For example, members inside the solid line represent members willing to receive bar promotions, numbers inside the dash line represent members willing to receive movie promotions, and numbers inside the dotted line represent members willing to receive food promotions. Members may indicate as many or as few preferences as they desire to obtain the type of promotional information they wish to receive.

Where overlaps occur, the described system and method may offer a conflict resolution functionality, such as allowing advertisers to submit bids for the right to promote to those particular users in an auction setting hosted by the system. Referring now to FIG. 2, an identified member represented by the number ‘2’, highlighted by the arrow, presents a case of a member willing to receive three messages who is interested in bar, movie, and food promotions. Although the member is interested in all three promotions, the member has only opted to receive two message. Accordingly, each advertiser may enter price-based bidding against each other to earn/purchase the right to send their message to that particular member, among other members.

The described system and method establishes an auction between promoters seeking the same groups of specific members, the target audience, as defined by the selection criteria. The winner of the auction may be the promoter that offers the highest per-message bid, the highest flat rate, etc. The winning promoter may obtain the exclusive right to send their message, through the system, to that group of members on that particular night. On a given night, there may be multiple auctions running simultaneously, covering multiple demographic areas involved and multiple user groups and/or a mix of the above.

Each member may or may not fall into multiple auctions based on their preferences. For example, the member willing to receive 2 messages in the overlap section of FIG. 2, will receive a message from the two highest bidders, provided they are included in the promoter's search criteria set (e.g., age, location, etc.). In FIG. 2, a food promoter has bid $15 and a bar promoter has bid $10 for the group of members, so the member in overlap will receive messages from those two promoters, instead of a movie promoter who only bid $5.

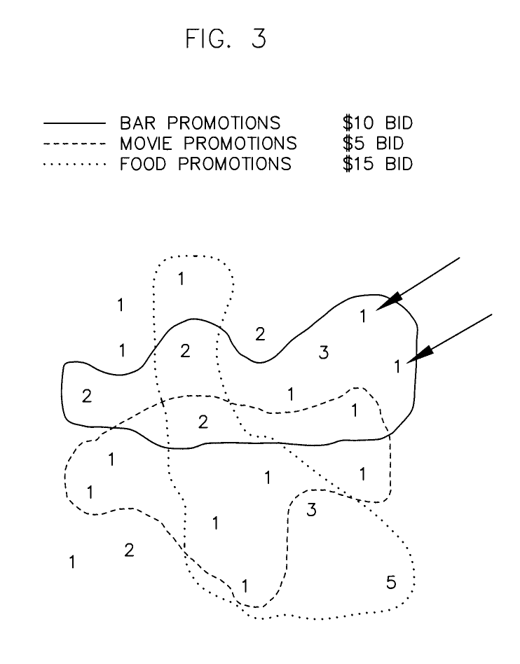

Each promoter only competes for the right to message members who fall into overlaps. A promoter may be able to easily bid a very low amount and “win” all members who only fall into their subset of criteria, with no overlaps. For example, referring to FIG. 3, the two members represented by a ‘1’, indicated by the arrows, will be won and messaged about bar promotions, and the bar promoter is the only promoter matching that criteria in this example.

The promoter may support the profitability of the described system in two ways. The first is by providing the messages which are sent to users and may be delivered at a per message charge which can vary as described below based on a rating system. In addition, a feature of the invention is to allow a plurality of venues to bid for the opportunity to send the messages to the targeted customers.

The timing of the auction can vary depending upon the type of promotion. The described system may be configured such that that service will initially involve an auction that closes by a set time prior to the targeted event time. For example, the auction could close at midnight of the day before for “after work” drink specials that begin at 5:00. Alternatively, the auction could conclude at noon, or even 7:00 at night, for events as club promotions which do not generate peak business until late evening and early morning.

The system may also implement “buy it now” promotions where a promoter may at the last moment, reach a target audience for a set fee, with a possible caveat that certain numbers of the target group who have reached their own designated limit on message receipts may be missed. These buy-it-now opportunities would be excellent to replace customers lost by last minute cancellations of large groups at restaurants, last minute recognition of competition with major events such as baseball or basketball games, cancellation of events and the like. The system may further be configured to offer packages that include a certain number of messages for a certain flat fee amount.

Another additional feature that can be included is to provide directions to the event, using known systems.

The accounting for the auction results may be handled on a credit card or direct bill basis, as is common with other auctions sites. Participation itself may be free for both members and promoters. The promoters may pay for the rights to their search-targeted list and/or a per-massage rate. The promoters have a choice whether to participate at any given time or to drop the service. They will be able readily to determine the effect of their promotions by business increase. For example, if a bar is running a promotion for drink specials, showing the text message to the bartender could be used as a way of tracking who has received the information by word of mouth and who has received it from the system of the present invention. “System only” promotions could be used as a marketing tool for both the described system and its customers.

One advantage of the present system is that good will is created in the member base when quality promotions are provided. This insures that promoters get what they expect and that the users receive quality “deals” which are of value to them and relevant to their interests.

Accordingly, the members, in the most preferred embodiment, have the ability to rate the offers they receive and directly affect the value to the promoter of the system experience. While it sounds somewhat counter-intuitive, the promoters who send out the most successful and well-received offers may receive discounts on the per message delivery charge, even though over time the value of the auction bid required to obtain access may or may not increase. A promoter may pay a flat per message fee on its initial offers, and may see that amount increase or decrease, or even be offered free distribution, in the event offers are receiving positive feedback and generating “Buzz” for the system, overall increases in the database or generating high member ratings.

Financial and brand image values will offer incentive to promoters to provide valuable messages to members and duly allow members to have a say in dictating community content. The rating of message to impact advertising price allows the market to set is own “fair market value” for the value of its community members. The rating may be handled in a variety of ways, including advertising to users the importance of their feedback and the enhancements of their overall experience with the system. For instance, promoters may also be able to rate members by determining the number converted into customers at the venue. They can rate them for VIP status and potentially upgrade offers to specific groups of members within their target audience.

The system may further be configured to monitor the offers both for potential objectionable content or violation of the rules. The system may require promoters to make legitimate offers of perceived value, which may or may not include informational announcements. Both members and promoters may be made aware of the overall process that is used to generate value-oriented offers but not be made aware of the financial results of any auction.

It may be possible to forward system text messages, but the system may desire to prevent such forwarding. One technique for preventing message forwarding may include, e.g., showing the number from which the message was sent (a system specific number) which the promoters also knows is authorized. In fact, the promoters may be willing and anxious, as may system promoters, for people to forward the calls to their own friends. Accordingly, the system may or may not restrict message forwarding to certain promoters based on average spend rate and member ratings.

Although auctioning is described generally, it should be understood that many different types and system of auctioning may alternatively be used to implement the functions described herein.

One system which may be used to facilitate group messaging, including registration, verification, and otherwise managing a messaging system and which may readily be adapted for use with the present invention, is described in the following commonly-owned United States provisional and utility patent applications:
1) Provisional Patent Application No. 60/838,961 entitled “Messaging System and Process”, filed on Aug. 21, 2006; and
2) utility patent application Ser. No. 11/894,674 entitled Messaging System and Process”, filed on Aug. 21, 2007.

The disclosures, drawings, specification, techniques, and other information disclosed/claimed therein are expressly incorporated herein as if fully set forth.

Embodiments within the scope of the present description include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above are also to be included within the scope of computer-readable media. Computer-executable instructions comprise, for example, instructions and data which cause a general purpose computer, special purpose computer, or special purpose processing device to perform a certain function or group of functions.

The invention is described in the general context of a process, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

Software and web implementations of the present invention could be accomplished with standard programming techniques with rule based logic and other logic to accomplish the various database searching steps, correlation steps, comparison steps and decision steps. It should also be noted that the word “component” as used herein and in the claims is intended to encompass implementations using one or more lines of software code, and/or hardware implementations, and/or equipment for receiving manual inputs.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A system for providing targeted promotional message to a self-selected group of members, comprising:
a member database including a plurality of member profiles, each member profile having at least:
a region designation;
a promotional message preference selection, and
a message quantity selection; and
a messaging engine configure to transmit one or more messages to at least one member in the member database based on the member profile for that member.

2. The system of claim 1, wherein the member profile further includes a message timing selection.

3. The system of claim 1, wherein the system further includes a promotional auction engine, the auction engine configured to allow a promoter to submit a bid for the right to send a promotional message to one or more of the members.

4. The system of claim 3, wherein the auction system is configured to include an auction timing function configured to award the right based on a the winning bid at a predefined time before the promotional message is scheduled to be sent.

5. The system of claim 3, wherein the promotional auction engine is triggered based on detection of multiple promoters seeking to send a promotional message to a user that is only willing to accept a number of promotional messages that is less than the number of promoters.

6. The system of claim 1, wherein the system further include a promoter rating engine configured to allow members to provide feedback regarding promotional messages generated by a promoter.

7. The system of claim 1, wherein the promoter rating engine is further configured to allow promoter to rate one or more members.

8. A method for providing targeted promotional message to a self-selected group of members, comprising:
receiving a promotional message transmittal request from a promoter, the request including a promotional message type, a member demographic selection, and a message transmittal timing selection;
selecting one or more members from a database based on the promotional transmittal request and a member profile associated with each member; and
transmitting the promotional message to the selected one or more members.

9. The method of claim 8, further including detecting a race condition in which two or more promoters have expressed an interest in sending a promotional message to a particular member, wherein the member has selected a constraint such that only one message should be transmitted; and
auctioning a right to transmit a promotional message to the member.
